(19) United States
(12) Patent Application Publication
(10) Pub. No.: US 2003/0021662 A1
(43) Pub. Date: Jan. 30, 2003

(54) Powered drive for vehicle spare tire hoist

(76) Inventor: Edward Ramsey, San Jacinto, CA (US)

Correspondence Address: Charles H. Thomas, CISLO & THOMAS LLP, Suite 405, 4201 Long Beach Blvd., Long Beach, CA, 90807-2022, US

(21) Appl. No.: 09/917,085

(22) Filed: Jul. 30, 2001

(51) Int. Cl. B62D 43/00; B66D 1/54

(52) U.S. Cl. 414/463; 414/909; 414/323; 414/328

(57) ABSTRACT

An electrically operated hoist control is provided which has an accessory to aid in lowering and raising a spare tire stored beneath the undercarriage of a vehicle, such as a pickup truck, van, or sport utility vehicle. The accessory includes a reversible, direct current motor and speed reducing gearing. The accessory is mounted to the underside of the vehicle proximate a conventional, manually operated spare tire hoist that has a rotatable, mechanical drive input. The output drive of the speed reducing gearing is coupled to the drive input of the conventional vehicle spare tire hoist in place of the conventional extension from the hoist drive input that is accessible at the rear bumper of the vehicle. The accessory includes an automatically resetting circuit breaker, such as a bimetal circuit breaker which trips when excessive amperage is drawn by the reversible direct current motor. A manual actuating switch is located at the rear bumper and can be operated in either direction to drive the direct current motor to alternatively raise and lower the vehicle spare tire. The accessory is wired through the ignition in the vehicle cab so that the actuating switch is not operable without actuation of the vehicle ignition switch.

### BACKGROUND OF THE INVENTION

1. Field of the Invention

The present invention relates to an electrically powered control system for operating a spare tire hoist to lower and raise a spare tire stored beneath the undercarriage of a vehicle.

2. Description of the Prior Art

In many heavier duty general purpose vehicles that are currently utilized, the vehicle spare tire, provided as basic equipment on nearly all automotive vehicles, is stored beneath the undercarriage of the vehicle in a generally horizontal disposition. Many pickup trucks, sport utility vehicles, vans, and other vehicles having sufficient ground clearance include an arrangement for storing the vehicle spare tire directly under the undercarriage, beneath the floor at the rear of the vehicle. Such a storage arrangement is advantageous in that the vehicle spare tire does not occupy valuable trunk or cargo storage space, since it is located beneath the bed or rear floor of the vehicle. Furthermore, storage of the spare tire in this location also avoids the visual obstruction to the vehicle driver that exists when spare tire storage is on the rear door or tailgate of the vehicle. Also, storage of the vehicle spare tire beneath the rear deck of the vehicle avoids excessive weight on the hinges of a rear vehicle door that occurs when a spare tire is hung on a storage rack mounted on the outside of the vehicle door.

In a conventional spare tire storage system in which the spare tire is stored on the underside of the vehicle a hoist mechanism is supplied for raising and lowering the spare tire. This hoist mechanism is typically a manually operated system in which the spare tire jack handle, tire iron, or some other tool provided with the vehicle is employed to operate the hoist mechanism to lower and raise the spare tire. However, conventional systems of this type are difficult to operate, as they often require considerable physical strength on the part of the person attempting to take a spare tire out of its storage location, or return it to that location.

Various electrically operated spare tire hoist control systems have been devised for use in raising and lowering a vehicle spare tire stored beneath the undercarriage of the vehicle. One such device is described in U.S. Pat. No. 4,613,273. In this system a tire winch is mounted underneath a vehicle, such as a truck, and is operated by a winch driven by a reversible electric motor through a worm drive mechanism. A switch is employed to power the motor to operate the winch in either direction. The switch made be a key-operated switch located adjacent the spare tire assembly or it may be a standard toggle-type switch mounted within the interior of the vehicle.

One significant problem with the arrangement disclosed in this prior patent is that there is no safeguard against over winding the winch when raising the spare tire back to its stored position. Unless the user is extremely careful, the spare tire can be brought up to its stored position from which it can be raised no further while the hoist motor is still being operated. If power is not cut off to the motor by operating the switch at the precise moment that the spare tire reaches its stored position, the motor will continue to operate to attempt to raise the spare tire further. This can result in burnout of the motor or the hoist cable can break. On the other hand, if power to the motor is terminated too early when raising the spare tire back to its stored position, the spare tire will rattle against the underside of the vehicle when the vehicle is driven. Also, if the spare tire is not fully returned to its stored position, it can become detached from the hoist mechanism as the vehicle travels and drop to the road without the driver noticing that the spare tire has been lost.

### SUMMARY OF THE INVENTION

The present invention provides an improved electrically operated system for raising and lowering a spare vehicle tire relative to a storage position located beneath the undercarriage or rear deck of the vehicle. The present invention provides a safeguard that ensures that the electric motor operating the hoist is shut off at precisely the proper time when raising the vehicle spare tire to its stored position beneath the vehicle. Specifically, the system of the present invention provides an electrical load-sensitive shut off device that is coupled in circuit with the electrical power inputs to the motor. As the spare tire is raised upwardly to the point at which it meets the undersurface of the vehicle or some other structure that prevents it from being raised further, the motor pulling on the hoist cable is subjected to an increased load. This electrical load increase causes the amperage drawn by the motor to increase. The electrical load-sensitive shut off device that is located in circuit with the electric motor is thereupon activated and cuts off current to the motor. The load-sensitive shut off device may, for example, be a self resetting circuit breaker, such as a bimetal circuit breaker. Alternatively, the system may be designed so that a reset signal is generated once the electrical switch used by the operator of the device is returned to the off position.

In one broad aspect the invention may be considered to be an automated accessory for a spare tire hoist for an automotive vehicle of the type having a direct current power source and a spare tire stored in a horizontal orientation beneath the underside of the vehicle body. The vehicle also includes a hoist with a rotatable drive input for raising and lowering the spare tire.

The automated accessory of the invention is preferably comprised of an accessory case secured beneath the underside of the vehicle proximate the spare tire hoist. The accessory also includes a bidirectional direct current motor mounted in the accessory case and having a motor output drive shaft and electrical input leads. Speed reduction gearing is coupled to the motor output drive shaft. The speed reduction gearing has a gear output drive shaft. A coupler extends from the gear output drive shaft for engagement with the hoist rotatable drive input. A load-actuated circuit breaker is located within the accessory case and is coupled in circuit with the electrical input leads to the motor. The circuit breaker has accessory power leads extending from the accessory case for connection to the direct current power source of the vehicle. An actuating electrical switch is coupled in circuit with the accessory power leads and is located remotely from the motor. The actuating switch alternatively drives the motor in opposite directions and is also operable to cut power to the motor entirely. The accessory automatically raises or lowers the vehicle spare tire relative to the underside of the vehicle body, depending upon the position of the actuating switch.

In another aspect the invention may be considered to be an improvement in an automotive vehicle having a direct current power source, a vehicle body, a spare tire oriented in a horizontal disposition and stored on the underside of the vehicle body, a spare tire hoist mounted on the underside of the vehicle body for raising and lowering the spare tire and including a rotatable hoist drive input. The improvement of the invention is comprised of a power driven hoist control. The hoist control of the invention includes a bidirectional direct current motor secured to the underside of the vehicle body in proximity to the hoist drive input and having a rotary motor output shaft. The hoist control also includes a motor speed reducer connected to the motor output shaft and a hoist drive adapter connected to the motor speed reducer and to the hoist drive input. A load-actuated current interrupter is connected to the electrical power inputs of the motor. A remote motor switch is provided for alternatively operating the motor to rotate the motor shaft in either of two opposite directions of rotation and to shut off current to the motor entirely.

Considered in still another aspect, the invention may be described as an improvement to an automotive vehicle having a direct current power source, a vehicle body that includes a rear deck, a spare tire oriented in a horizontal disposition and stored beneath the rear deck, and a spare tire hoist for raising and lowering the spare tire located beneath the rear deck and having a rotatable hoist drive input.

The improvement of the invention is an automated spare tire hoist accessory. The spare tire hoist accessory of the invention includes a bidirectional direct current motor, speed reduction gearing, a coupling, an electrical load-sensitive shut off device, and an actuating switch. The hoist control preferably includes an accessory housing which is secured beneath the rear deck proximate the spare tire hoist. The bidirectional direct current motor is located within the accessory housing and has electrical power inputs and a motor output shaft. The speed reduction gearing is located within the accessory housing and is connected to the motor output shaft. The speed reduction gearing has a gear output shaft. The coupling is attached to the gear output shaft and to the rotatable hoist drive input. The electrical load-sensitive shut off device is located in the accessory housing and is coupled in circuit with the electrical power inputs to the motor. The actuating switch is located remote from the accessory housing and is alternatively operable to drive the motor output shaft in opposite directions and to shut off current to the motor.

The automated spare tire hoist accessory of the invention provides a positive safeguard against overwinding the hoist cable. Once the cable has been fully tightened as the spare tire is pulled up against the undersurface of the vehicle, the increased resistance increases current to the electric motor. Once the current to the electric motor rises to a threshold level, the electrical load-sensitive shut off device cuts off power to the electric motor, thereby preventing damage to the motor or to the hoist cable.

Preferably, the actuating switch is a three-way switch that is externally located at the rear of the vehicle. Preferably also the automated spare tire hoist accessory of the invention is wired through the vehicle ignition system. The location of the three-way switch at the rear and on the exterior of the vehicle allows a user to operate the spare tire hoist accessory of the invention while standing at the rear of the vehicle. This is the most convenient position for the operator to gain access to the spare tire. However, by wiring the hoist motor through the ignition switch of the vehicle, the system of the invention serves as a theft prevention device so that a thief cannot merely operate the accessory as an aid in stealing the spare tire. To the contrary, unless the user has the ignition key and turns it on, the system will remain disabled. Moreover, since the accessory coupling is attached to the rotatable hoist drive input, a thief cannot gain access to the hoist operating mechanism to manually lower the hoist. The automated accessory of the invention thereby serves as a very effective spare tire antitheft device.

Another very advantageous feature of the invention is its retrofit capability. The automated spare tire hoist accessory of the invention can be mounted on the undercarriage of a vehicle to convert a conventional manual spare tire hoist to a power driven spare tire hoist. The hoist accessory of the invention is easily installed by anyone having basic mechanical and electrical wiring skills.

The invention may be described with greater clarity and particularity by reference to the accompanying drawings.

### DESCRIPTION OF THE DRAWINGS

FIG. 1 is a sectional elevational view illustrating the installation and operation of an automated spare tire hoist accessory according to the invention

FIG. 2 is an electrical schematic diagram illustrating the wiring connections for the automated spare tire hoist accessory of the invention.

FIG. 3 is a transverse sectional detail illustrating an alternative embodiment of a coupling to that illustrated in FIG. 1.

### DESCRIPTION OF THE EMBODIMENT

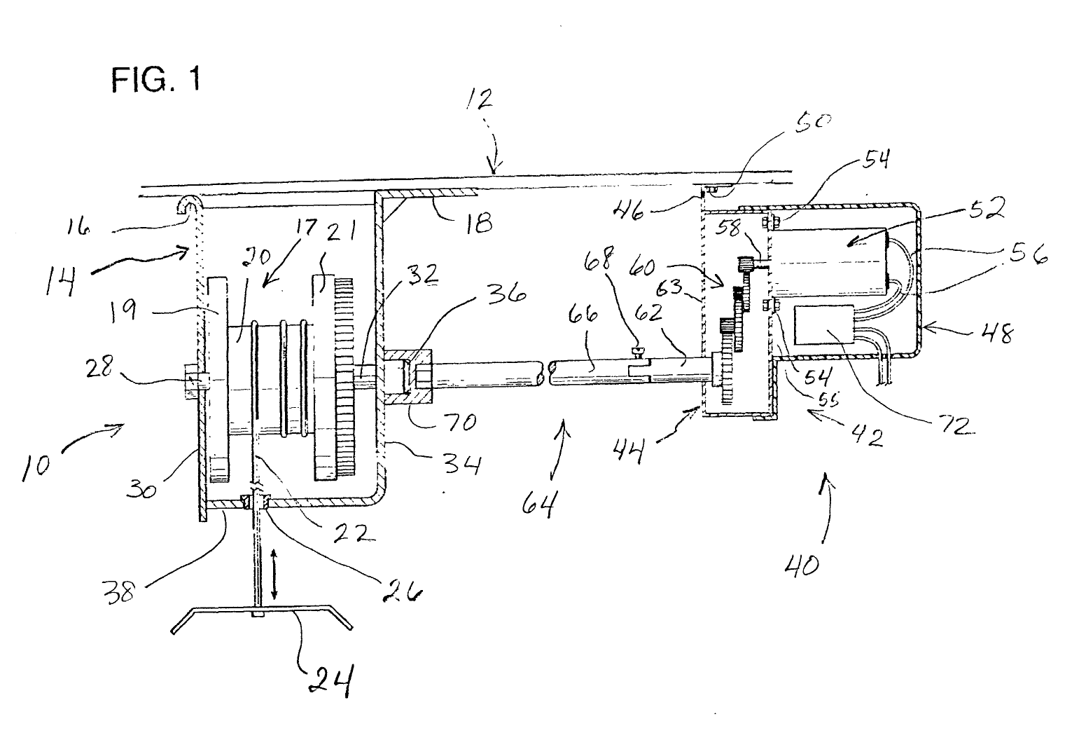

FIG. 1 illustrates a conventional manual vehicle spare tire hoist system 10 of the type often installed as original equipment on a pickup truck, a sport utility vehicle, or a van. The conventional, manual hoist 10 is mounted on the underside of the rear deck 12 at the undercarriage of an automotive vehicle. The manual hoist 10 has a hoist housing 14 with base feet or flanges 16 and 18 that are bolted or otherwise secured by conventional means to the underside of the deck 12 beneath which the hoist 10 is located.

The conventional, manually operated spare tire hoist 10 includes a reel 17 having disc-shaped end plates 19 and 21 at opposite ends of a cylindrical drum 20 upon which a hoist cable 22 is wound. The hoist cable 22 is typically a stranded wire cable, one end of which is anchored to the drum 20, and the other end of which is coupled to a grappling bar 24. The cable 22 passes through a hole in the bottom plate 38 of the tire hoist housing 14. The hole in the plate 38 is typically lined with an annular plastic bushing 26 to avoid metal to metal contact between the cable 22 and the spare tire hoist housing 14.

The reel 17 has an axis of rotation that is aligned relative to the vehicle in a fore and aft direction at the undersurface of the vehicle. At one of its ends the drum 20 has a central axle well that receives a stub axle 28 that passes through an opening in the forward upright wall 30 of the hoist cable housing 14. At its opposite end the cable drum 20 has a cylindrical axle shaft 32 that extends in an aft direction outwardly through an opening in the opposite rear wall 34 of the cable housing 14. A connecting stud 36 is secured to the end of the axle shaft 32 that protrudes outwardly through the rear housing wall 34. The connecting stud 36 has a polygonal cross section. In a Chevrolet pickup truck, for example, the base of the stud 36 adjacent the rear wall 34 is three-eighths inches square and the longitudinally aft facing end of the cap 36 is swedged down to a slightly smaller cross section.

In the conventional installation and manual operation of the spare tire hoist 10 the hoist housing 14 is attached to the vehicle chassis not too distant from the longitudinal center line of the vehicle beneath the deck 12 with the connecting stud 36 directed rearwardly and located between about twelve and thirty-six inches from the rear bumper of the vehicle. In the original installation of the manually operated spare tire hoist 10 there is a coupling rod that has a three-eighths inch socket engaged with the connecting stud 36 and which extends rearwardly to an opening in the rear bumper of the vehicle.

In the original installation in the vehicle the end of the Z-handle jack crank or L-shaped tire iron that is used to operate the vehicle tire jack supplied as standard equipment with the vehicle is engaged with the end of the coupling rod protruding through an opening in the bumper. The jack handle crank is rotated in a direction that winds the cable 22 onto or reels it off of the drum 20. With the cable 22 extended out of the housing 14, the grappling bar 24 is tilted so that it can be inserted through the axle opening in the center of the hub of the spare tire of the vehicle. The grappling bar 24 is then reoriented so that its ends engage the underside of the hub of the spare tire. By cranking in one direction of rotation on the stud 36 the spare tire is drawn upwardly until its hub seats against the bottom plate 38 of the hoist housing 14. The operator can tell by the resistance felt when the spare tire has been fully drawn up against the hoist housing 14.

To lower the spare tire, the Z-handle crank or L-shaped tire iron is rotated in the opposite direction, thereby rotating the connecting stud 36 in the opposite direction. The cable 22 is thereupon reeled off of the drum 20 of the reel 17 to lower the spare tire to the ground.

It should be noted that the operation of the conventional, manual spare tire hoist 10 can be performed by any individual having an appropriate Z-handle crank or L-shaped tire iron. Thus, there is nothing to prevent a thief from operating the manual spare tire hoist 10 and stealing the spare tire from a vehicle parked in an unattended parking lot or from a vehicle parked on the street.

According to the present invention the prior manual spare tire hoist system is retrofitted with an automated spare tire hoist accessory 40. The spare tire hoist accessory 40 includes an accessory housing 42 formed of a metal, box-shaped portion 44 having an upwardly extending, L-shaped attachment flange 46 and a plastic cover 48. The cover 48 has a lip on its open side that fits over the box 44. The attachment flange 46 has a leg that resides in face-to-face contact against the underside of the rear vehicle deck 12. The leg of the flange 46 is attached to the deck 12 by self tapping screws 50 so that the accessory housing 42 is secured to the vehicle underside beneath the vehicle body proximate the spare tire hoist 10 and between the spare tire hoist 10 and the rear bumper of the vehicle.

A bidirectional direct current electric motor 52 is located within the accessory housing 42. The motor 52 has attachment flanges that are secured by bolts 54 to the facing covered rear end wall 55 of the metal box-shaped enclosure 44. The motor 52 has electrical power input wires 56 and a motor output shaft 58.

The hoist accessory 40 also includes speed reduction gearing 60 located within the accessory housing 42. Different types of speed reduction gearing may be employed, but in the preferred embodiment of the invention the speed reduction gearing 60 is comprised of a cluster of spur gears and pinions that terminate in a gear output shaft 62 that extends forwardly through the opposite forward end wall 63 of the metal enclosure 44 opposite the wall 55 upon which the motor 52 is mounted. The motor 52 at normal operation draws a current of 7.2 amperes to rotate the gear output shaft 62 at 70 rpm.

A hoist drive adapter in the form of a coupler 64 is attached to the gear output shaft 62 and to the rotatable hoist drive input connector stud 36. The coupler 64 is comprised of a rod 66, one end of which receives the exposed end of the gear output shaft 62 and is secured thereto by a set screw 68. A socket 70 is secured to the other end of the rod 66. The socket 70 defines within its structure a cavity having a square cross section adapted to receive the connector stud 36 at the end of the axle shaft 32 snugly therewithin.

The spare tire hoist accessory 40 also includes an electrical load-sensitive shut off device, which in the preferred embodiment of the invention is a bimetal circuit breaker 72. The circuit breaker 72 is located in the accessory housing 42 and is coupled in circuit with the electrical power inputs 56 to the motor 52. When the motor 52 reaches a stall condition as the spare tire is drawn up against the bottom plate 38 of the spare tire hoist housing 14, the bimetal circuit breaker 72 heats up and breaks the power connection to the electrical power inputs 56 to the motor 52. This shuts off the motor 52 without damaging it. With the interruption of power the bimetal circuit breaker 72 cools, thereby resetting itself.

The adapter housing 42 forms an accessory mount defining a hollow enclosure formed by confining walls that encapsulate the motor 52, the speed reducing gearing 60, and the load-actuated current interrupter, namely the bimetal circuit breaker 72 therewithin. The housing 42 has a wall opening for the output drive shaft 62 of the speed reducing gearing 60.

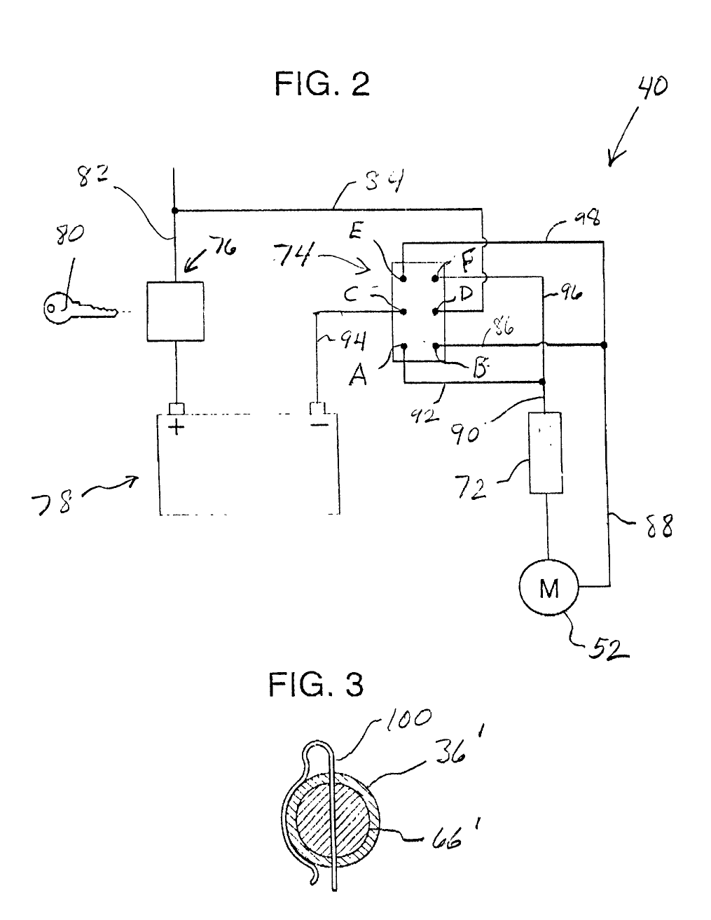

The spare tire hoist accessory 40 also includes an enabling three position switch 74, which is preferably a rocker switch. The switch 74 is located remote from the accessory housing 42, and is preferably positioned in the opening in the bumper originally provided to receive the manually operable coupling connector provided as original equipment for the spare tire hoist 10. The appropriate one of a plurality of inexpensive, plastic adapters designed for each different size and shape of different openings in the vehicle bumpers of different vehicles is utilized to ensure that the switch 74 is firmly mounted in the vehicle rear bumper opening. The remote switch 74 is thereby located externally at the rear of the vehicle. As shown in FIG. 2, the enabling switch 74 is alternatively operable to drive the motor output shaft 58 in either of two opposite directions of rotation, and to shut off current to the motor 52 entirely.

The vehicle with which the hoist accessory 40 is used has an enclosed cab with a dashboard or steering wheel column having with an ignition switch 76 mounted therein. Also, the remote motor switch 74 is coupled to the direct current power source of the vehicle, specifically the lead acid storage battery 78, through the vehicle ignition switch 76. Consequently, unless a vehicle ignition key 80 has been used to enable the ignition switch 76, no current will flow to the motor 52. That is, electrical current will flow to the line 82 and on to line 84, which is coupled to the positive terminal D of the rocker switch 74, only when the ignition key 80 has been used to activate the vehicle ignition switch 76. As a consequence, even if the rocker switch 74 is pressed in the direction to operate the spare tire hoist 10 to lower the spare tire, the motor 52 will not operate unless the ignition switch 76 has been actuated. This feature of the invention serves as a theft prevention device to safeguard the spare tire.

Once the ignition switch 76 is actuated by the key 80, however, operation of the rocker switch 74 in either of two opposite directions from a null position will provide an electrical current flow to the motor 52. Actuation of the rocker switch 74 in one direction from the null position will concurrently connect terminal D with terminal B and terminal C with terminal A. These connections will cause electrical current to flow from the line 84 through terminals D and B, through electrical lines 86 and 88 to the motor 52, with a return path through the bimetal circuit breaker 72 and through lines 90 and 92, terminals A and C, then through line 94 to vehicle ground.

Conversely, operation of the rocker switch 74 in the opposite direction will concurrently connect terminal D to terminal F and terminal C to terminal E. With these connections electrical current will flow from line 84, through terminals D and F, through lines 96 and 90 and the bimetal circuit breaker 72 to the motor 52. The return path from the motor 52 is through lines 88 and 98, through terminals E and C, and through line 94 to vehicle ground.

With the rocker switch 74 in the center or null position a voltage differential exists between terminals D and C. However, since there are no connections to those terminals there is no current flow and no actuation of the motor 52.

Undoubtedly, numerous variations and modifications of the invention will become readily apparent to those familiar with vehicle spare tire hoists. For example, different models of vehicles have different configurations for the rotatable hoist drive input. In a Dodge pickup truck, for example, the hoist drive input is not a square, male stud, like the connecting stud 36, but rather a hollow, steel female tube 36′ having a pair of diametrically opposed holes therethrough, as illustrated in FIG. 3. The coupler or adapter 64 therefore must have a different configuration to engage the hollow spare tire hoist drive input tube 36′. For this connection the adapter or coupler extending between the gear output drive shaft 62 and the hollow tube 36′ is a solid rod 66′ having a bore defined diametrically therethrough. The transverse bore through the rod 66′ is of a size and is at a location to align with the corresponding diametrically opposed apertures in the tube 36′. A cotter pin 100 is then used to engage the end of the rod 66′ with the hoist drive input tube 36′.

Other vehicles have different configurations for their rotatable hoist drive inputs. An adapter having an appropriate mating configuration is therefore provided to match the corresponding hoist drive input configuration of the model of the vehicle involved. Accordingly, the scope of the invention should not be construed as limited to the specific embodiments depicted and described, but rather is defined in the claims appended hereto.

I claim:

1. An automated accessory for a spare tire hoist for an automotive vehicle having a direct current power source and a spare tire stored in a horizontal orientation beneath the underside of a vehicle body and including a hoist with a rotatable drive input for raising and lowering said spare tire comprising:
a bidirectional direct current motor for mounting beneath said underside of said vehicle body proximate said spare tire hoist and having a motor output drive shaft and electrical input leads,
speed reduction gearing coupled to said motor output drive shaft and having a gear output drive shaft,
a coupler extending from said gear output drive shaft for engagement with said hoist drive input,
a load-actuated circuit breaker coupled in circuit with said electrical input leads to said motor and having accessory power leads for connection to said direct current power source of said vehicle, and
an actuating electrical switch coupled in circuit with said accessory power leads and located remotely from said motor for alternatively driving said motor in opposite directions and for cutting power to said motor entirely.

2. An automated accessory according to claim 1 wherein said hoist drive input is a shaft with a drive-engaging end having a polygonal cross section, and said coupling includes a socket defining a cavity of polygonal cross section that is positioned in seated engagement upon said drive-engaging end.

3. An automated accessory according to claim 2 wherein said drive-engaging end and said cavity of said socket both have a square cross section.

4. An automated accessory according to claim 1 wherein said hoist drive input is a cylindrical drive tube having diametrically opposed, transverse openings defined therethrough and said coupler includes a rod having a bore defined diametrically therethrough and said rod is disposed within said drive tube, and a transverse pin extends through said diametrically opposed openings in said tube and through said transverse bore in said coupler rod.

5. An automated accessory according to claim 1 further comprising an accessory case containing said motor, said speed reduction gearing, and said circuit breaker.

6. An automated accessory according to claim 1 wherein said load-actuated circuit breaker is a bimetal circuit breaker.

7. In an automotive vehicle having a direct current power source, a vehicle body, a spare tire oriented in a horizontal disposition and stored on the underside of said vehicle body, a spare tire hoist mounted on said underside of said vehicle body for raising and lowering said spare tire and including a rotatable hoist drive input, the improvement comprising a power driven hoist control including:
a bidirectional direct current motor secured to said underside of said vehicle body in proximity to said hoist drive input and having a rotary motor output shaft,
a motor speed reducer connected to said motor output shaft,
a hoist drive adapter connected to said motor speed reducer and to said hoist drive input,
a load-actuated current interrupter connected to said electrical power inputs of said motor, and
a remote motor switch for alternatively operating said motor to rotate said motor shaft in either of two opposite directions of rotation and to shut off current to said motor entirely.

8. An automotive vehicle according to claim 7 wherein said motor speed reducer is comprised of a plurality of gears and pinions.

9. An automotive vehicle according to claim 7 wherein said remote switch is located externally at the rear of said vehicle.

10. An automotive vehicle according to claim 9 wherein said vehicle has an ignition switch within its confines and said remote motor switch is coupled to said direct current power source through said ignition switch.

11. An automotive vehicle according to claim 7 wherein said load-actuated current interrupter is a bimetal circuit breaker.

12. An automotive vehicle according to claim 7 further comprising an accessory housing encapsulating said motor, said motor speed reducer, and said load-actuated current interrupter therewithin.

13. An automotive vehicle according to claim 12 wherein said motor speed reducer has an output drive and said accessory housing defines a hollow enclosure formed by confining walls and said hollow enclosure has a wall opening for said output drive of said motor speed reducer.

14. In an automotive vehicle having a direct current power source, a vehicle body that includes a rear deck, a spare tire oriented in a horizontal disposition and stored beneath said rear deck, and a spare tire hoist for raising and lowering said spare tire located beneath said rear deck and having a rotatable hoist drive input, the improvement comprising an automated spare tire hoist accessory including:
a bidirectional direct current motor secured beneath said vehicle body proximate said spare tire hoist and having electrical power inputs and a power output shaft,
speed reduction gearing connected to said motor power output shaft and having a gear output shaft,
a coupling attached to said gear output shaft and to said rotatable hoist drive input,
an electrical load-sensitive shut off device coupled in circuit with said electrical power inputs to said motor, and
an actuating switch located remote from said motor and alternatively operable to drive said motor output shaft in opposite directions and to shut off current to said motor.

15. An automotive vehicle according to claim 14 wherein said automotive vehicle has an internal electrical ignition switch and said electrical power inputs of said motor are coupled to said direct current power source through said electrical ignition switch.

16. An automotive vehicle according to claim 15 wherein said actuating switch is located at the rear exterior of said vehicle.

17. An automotive vehicle according to claim 12 further comprising a housing forming an enclosure containing said motor, said speed reduction gearing, and said electrical load-sensitive shut-off device.

18. An automotive vehicle according to claim 14 wherein said load-sensitive shut-off device is a bimetal circuit breaker.
